(19) United States
(12) Patent Application Publication
(10) Pub. No.: US 2026/0027779 A1
(43) Pub. Date: Jan. 29, 2026

(54) METHOD FOR VARYING PHYSICAL PROPERTIES IN 3D-PRINTED PRODUCTS

(71) Applicant: Azul 3D, Inc., Skokie, IL (US)

(72) Inventors: Richard Schmidt, Skokie, IL (US); James Hedrick, Skokie, IL (US); David Walker, Skokie, IL (US)

(21) Appl. No.: 18/998,566

(22) PCT Filed: Jul. 28, 2023
(86) PCT No.: PCT/US2023/029043

§ 371 Date: Jan. 27, 2025

Related U.S. Application Data
(60) Provisional application No. 63/393,737, filed on Jul. 29, 2022.

(51) Int. Cl. B29C 64/386; B29C 64/129; B29C 71/04; B33Y 10/00; B33Y 40/20; B33Y 50/00

(52) U.S. Cl. CPC B29C 64/386; B29C 64/129; B29C 71/04; B33Y 10/00; B33Y 40/20; B33Y 50/00

(57) ABSTRACT

The present technology provides methods for varying physical properties in 3D printed products from a single resin composition, a single printing process, and a single curing process. An image stack used during the 3D printing process controls the position and intensity of light administered by a light source. The image stacks control an intensity of light to be used on different regions of the resin pool at different points in time to induce higher levels of polymerization in certain regions and lower levels of polymerization in other regions. Regions exposed to higher intensities of light will achieve a higher percent cure compared to regions exposed to lower intensities of light. The higher percent cure in a given region in a product will result in different physical properties after a post-print curing process when compared to a given region in the product with a lower percent cure.

### RELATED APPLICATION AND INCORPORATION BY REFERENCE

This application claims priority to U.S. provisional application No. 63/393,737, filed Jul. 29, 2022. The entire contents of which are incorporated by reference in its entirety.

### TECHNICAL FIELD

The technology disclosed herein relates to three-dimensional (“3D”) printing, and more particularly to methods for varying physical and mechanical properties in 3D-printed products.

### BACKGROUND

In the field of additive manufacturing, or three-dimensional (“3D”) printing, a variety of methods may be used to produce a final 3D-printed product. One conventional 3D printing technique, generally referred to as stereolithography, involves exposing a photopolymerizable resin to light in a patterned and sequential manner based on a computer-assisted design (“CAD”) to create a 3D product from the resin. Examples of energy sources used in stereolithography include a light projector, also known as Digital Light Processing (“DLP”), and lasers. Conventional stereolithography techniques utilize a layer-by-layer approach, which involves curing a discrete layer of resin with a light source and then moving that cured layer away from the light source so another layer of resin can replace it to be cured. The area and overall geometry of the finished product is dictated by the pattern of the light to which the resin is exposed. The light patterns are dictated by a sequential stack of images generated from a CAD.

Conventional layer-by-layer 3D printing techniques were developed to allow for rapid prototyping due to the ability to create customized products. However, conventional 3D printing techniques do not allow for a wide range of mechanical properties in a final product. Physical and mechanical properties of products produced using conventional liquid resin-based 3D printing processes are controlled by multiple factors, including the amount of cross-linking that occurs during the polymerization process, the network density, and the overall tightness or closeness of the components of the polymer network. The ratio of chain extension to cross-linking effects the mechanical properties of the final product. Products with high levels of cross-linking have higher rigidity compared to products with low levels of cross-linking. Products with low levels of cross-linking will have a higher degree of elasticity. 3D-printed products range from elastomeric to flexible to semi-flexible to rigid as the percentage of cross-linking in the 3D product increases. The amount of cross-linking that occurs is based on the resin formulation. Resins contain a certain amount of cross-linking agents based on the desired mechanical properties of the final product. Higher levels of cross-linking agents in the resin formulation lead to higher levels of cross-linking during the printing process. In conventional liquid resin-based 3D printing processes, the level of cross-linking is essentially uniform throughout the product such that the mechanical properties of the product are substantially uniform and do not vary, i.e., the entire product is substantially elastomeric, flexible, semi-flexible, or rigid.

### SUMMARY

The present technology provides methods for varying physical and mechanical properties or characteristics in 3D-printed products. A 3D-printed product may be created from a single resin composition, a single printing process, and a single curing process, such that the 3D-printed product has variable physical and/or mechanical properties throughout the product and/or a wide variety of physical characteristics. Variable physical and/or mechanical properties may be created by controlling different steps of the printing and curing process.

3D printing processes used to create products with varied physical properties (e.g., products with regions of differing elasticity, flexibility, rigidity, and optical properties (e.g., reflectivity, absorptivity, refractivity, transparency, translucency, opaqueness, luminescence), etc.) are dictated by an image stack that is used during the 3D printing process to control the position and intensity of light administered by the light source. Grayscale image stacks can be created that dictate an intensity of light to be used on different regions of the resin pool at different points in time to induce higher levels of polymerization (percent cure) from the printing process in certain regions and lower levels of polymerization (percent cure) in other regions. Regions exposed to higher intensities of light will achieve a higher percent cure from the printing process compared to regions exposed to lower intensities of light. Since all regions will achieve 100% cure when the post-print curing process is complete, regions with lower levels of percent cure from the printing process (photocuring) will have higher levels of percent cure from the post-print curing process (for example, photo and/or thermal curing). The higher percent cure in a given region in a product will result in different physical and/or mechanical properties after a post-print curing process when compared to a given region in a product with a lower percent cure that underwent the same curing process.

The resulting final product contains regions having differing physical and/or mechanical properties based on the percentage of the polymerization of resin in that region that occurred during the printing process compared to the percentage of polymerization in that occurred during the post-print curing process. Ratios of percent cure from printing to percent post-print cure achieve 3D-printed products having variable physical and/or mechanical properties throughout due to differing amounts of chain extension polymerization and cross-linking polymerization that occurs when different combinations of percent cure from printing and percent post-print cure are used for a given liquid resin formulation. The use of varying light intensity during stereolithography techniques to additively manufactured products creates products having varied physical and/or mechanical properties from a single resin formulation, a single printing process, and a single post-printing curing process based on differing ratios of polymerization from printing to polymerization from post-print curing in different regions of the product.

This technology allows 3D-printed products to have varying physical and/or mechanical properties and/or multiple mechanical characteristics providing an increase in customization of 3D-printed products. In addition, different 3D-printed products having different physical and/or mechanical properties and/or mechanical characteristics can be created from a single resin formulation saving costs as compared to the use of multiple resin formulations to create the different 3D-printed products.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

The drawings are appended hereto and form a portion of this disclosure.

FIG. 1 is an illustration depicting a representation of a uniform polymer network with an equal amount of cross-linking and chain extension.

FIG. 2 is an illustration depicting a representation of a polymer network with varying amounts of cross-linking.

FIG. 3 is an illustration depicting a representation of a polymer network with regions having differing ratios of chain extension to cross-linking.

FIG. 4 is an illustration depicting an example embodiment of a polymer network associated with a hinge.

FIG. 5 depicts stress versus strain curves for resins exposed to varying light intensities.

FIG. 6 is a block flow diagram depicting a method of producing articles having varying physical properties from a single resin formulation.

FIG. 7 is a block flow diagram depicting a method to generate an image stack from a 3D model of the article.

FIG. 8 is a method of producing articles with varying density from single resin formulation.

FIG. 9 is a block diagram depicting a computing machine and a module, in accordance with certain examples.

### DETAILED DESCRIPTION

The examples described herein provide methods for varying physical and/or mechanical properties or characteristics in three-dimensional (“3D”) printed products. A 3D-printed product may be created from a single resin composition, a single printing process, and a single curing process, such that the 3D-printed product has variable physical and/or mechanical properties throughout the product and/or a wide variety of physical characteristics. Variable physical and/or mechanical properties may be created by controlling different steps of the printing and curing process.

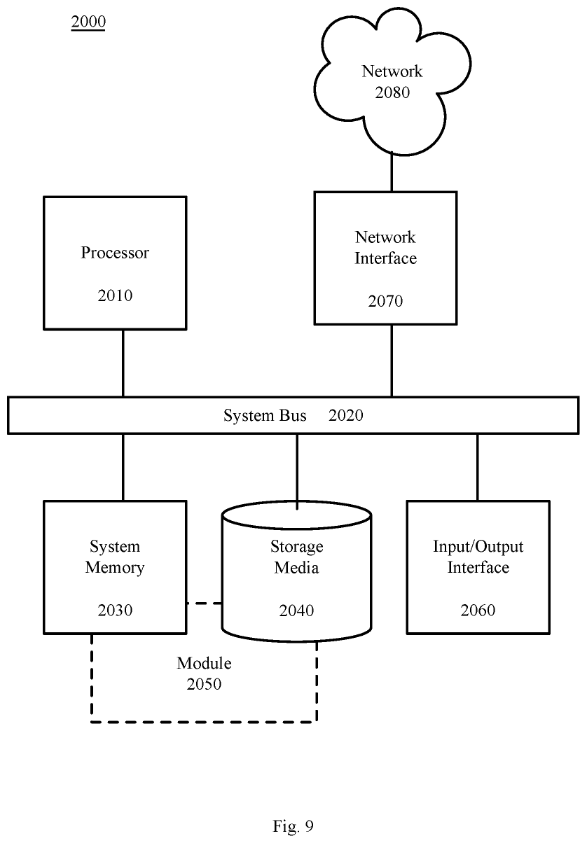

The network computing devices and any other computing machines associated with the technology presented herein may be any type of computing machine, such as, but not limited to, those discussed in more detail with respect to FIG. 9. For example, each device can include a server, a desktop computer, a laptop computer, a tablet computer, a television with one or more processors embedded therein and/or coupled thereto, a smart phone, a handheld computer, a PDA, a router, a switch, a hub, a gateway, a modem, an access point, a bridge, or any other wired or wireless processor-driven device. The computing machines discussed herein may communicate with one another, as well as with other computing machines or communication systems over one or more networks. Each network may include various types of data or communications networks, including any of the network technology discussed with respect to FIG. 9.

Furthermore, any functions, applications, or components associated with any of these computing machines, such as those described herein or any others (for example, scripts, web content, software, firmware, hardware, or modules) associated with the technology presented herein may by any of the components discussed in more detail with respect to FIG. 9.

In 3D printing applications, a variety of methods may be used to produce a final 3D-printed product. For example, layers of cured resin may be added in a “top-down” or a “bottom-up” method. Top-down methods involve exposing a pool of resin to a light source from above. Once a layer of resin is cured, the cured layer is moved deeper into the pool of resin away from the light source to allow uncured resin to flow over the cured region and become exposed to the light source. Bottom-up methods involve exposing a vat, or pool, of liquid resin to a light source from below through a window at the bottom of the vat. The cured resin is separated from the area of light exposure, or printing interface, and lifted out of the vat allowing uncured resin to flow into the window to be cured. Bottom-up methods allow more precise control over resin layer thickness.

In an example, bottom-up methods use a build platform onto which the resin cures. The build platform is attached to a vertical arm, which is attached to a linear actuator that moves the build platform away from the radiation source. The cured resin affixes to the build platform, which allows the partially formed product to be lifted out of the vat and uncured resin to flow and replace the cured resin. Layer-by-layer bottom-up techniques involve moving the build platform away from the printing interface at sequential, discrete intervals in order to control resin layer thickness. In an example, a bottom-up method may be a “continuous bottom-up” method. Continuous bottom-up methods involve moving the build platform away from the print interface in a continuous manner, which results in a layer-less 3D-printed product. Continuous bottom-up 3D printing can produce products at a faster rate than other layer-by-layer techniques.

In an example, cured resin affixing to the build platform is acceptable while cured resin affixing to the window is not. Cured resin affixing to the window may cause deformities in the product, prevent the product from moving with the build plate, or otherwise deteriorate the structural and functional integrity of the final product. In an example, a 3D printer may comprise mechanical dividers, non-sticking agents, chemical dead layers, and/or a flowing interface material between the window and the resin pool to prevent resin adherence to the window. In an example, High Area Rapid Printing (“HARP”) uses a layer of immiscible flowing fluorinated oil between the resin pool and the window to prevent adhesion and allow for continuous bottom-up 3D printing. The fluorinated oil passes through a cooling apparatus, which dissipates the heat generated by the exothermic resin polymerization process.

In an example, products generated using 3D printing techniques may need further processing of products after the printing process concludes. The product will not be fully cured because unreacted resin may still be present in and/or on the product after completion of the printing process. In an example, the product may be referred to as a “green” product. Various methods of processing a green product may have an impact on the physical and/or mechanical properties of the final product. In an example, processing a green product may comprise further curing the product outside of the printer by exposing the green product to light, heat, or a combination of light and heat. The exposure allows unreacted components present in or on the green product to finalize reaction. Finalizing the reaction, i.e., curing the product completely, may prevent deformities, defects, instability, or other non-advantageous mechanical properties in the final product.

In an example, multiple variables may be present that determine the type of curing that will be effective for a given green product including: the type of resin used, the geometry of the green product, the presence of thermal initiators to facilitate thermal curing, the desired physical and/or mechanical properties of the finished product, and the percentage of the green product to be cured. The variables affect multiple aspects of the post-print curing process including: the type of curing (e.g., photocuring, thermal curing, and/or a combination of photocuring and thermal curing), the length of time the green product is exposed to the different types of cures, the intensity of light for photocuring, the temperature(s) for thermal curing, and any other steps needed to ensure that the desired properties are present in the final product.

In an example, light intensity to which the liquid resin is being exposed may be controlled. Light intensity is measured as the total amount of photons administered to a 3D pixel, also referred to as a voxel. In an example, light intensity may be controlled by adjusting controls of the light source, adjusting a length of time the liquid resin is exposed to light (for example, effectively turning or flicking the pixels off and on for discrete intervals of time), adjusting a distance the light source is from a region of the resin pool, adding a filter to the light source, or any combination thereof. To create a final product with particular attributes (e.g., geometry, area, thickness, and size) in a liquid resin-based 3D printing process, energy may be administered to specific regions of the resin pool at specific points during the printing process. Administering the energy at specific points facilitates resin curing in the specific region to create the 3D product with the particular attributes using two-dimensional (“2D”) energy administration. The higher the resolution of the light source, the more precisely the structure (i.e., attributes) of the product can be defined. In an example, a grayscaling method allows for sub-pixel levels of definition in Digital Light Processing (“DLP”) 3D printing. Grayscaling involves exposing certain regions of resin in a same layer to different levels of light intensity by, for example, masking pixels or rapidly turning pixels off and on to control the total light intensity over a given pixel. For example, to achieve a greater intensity of light, a pixel may remain on for a longer period of time as compared to a shorter length of time to achieve a lower intensity of light. In an example, decreasing the intensity of light of pixels at a boundary of a product may produce a finished product with a smoother edge. In an example, grayscaling is associated with grayscale values assigned as a range from 0 to 1, wherein I is full exposure to light and 0 is no exposure to light. Grayscale values can be implemented into a computer-assisted design (“CAD”) to generate an image stack. For example, a 3D model may be generated in a CAD software providing a digital representation of the object to be printed. The 3D model is then sliced into a plurality of thin layers. Each layer corresponds to a cross-section of the model. The number of layers may depend on the resolution of the 3D printer, where more layers are created for higher resolutions. For each layer, a 2D grayscale image is generated. The grayscale values (ranging from black to white) in these images may represent the light intensity to be applied to a given section of the object as the object is printed. For example, black could represent the lowest intensity, white the highest intensity, and various shades of gray the points in between. In an example, a grayscale value of 1 for a specific voxel of an image could represent exposing that voxel to light for the entirety of the time it takes to print the region of the product represented by the image, and a grayscale value of 0 for a specific voxel of an image could represent exposing that voxel to no light for the entirety of the time that it takes to print the region of the product represented by the image. In an example, a grayscale value of between 0 and 1 for a specific voxel of an image could represent exposing that voxel to light for less than the time it takes to print the entire region of the product represented by the image. The image stacks dictate levels of light intensity to be exposed at different regions of the resin pool over the course of the printing process. In an alternate example when lasers are used in the 3D printing process, a similar effect may be achieved by altering an intensity of the laser during the printing process.

In one embodiment, a 3D printed product may be created from a single resin composition, a single printing process, and a single curing process, such that the 3D-printed product has variable physical and/or mechanical properties throughout the product and/or a wide variety of physical characteristics. Variable physical and/or mechanical properties may be created by controlling different steps of the printing and curing process. For example, light intensity may be controlled by a light control algorithm that comprises one or more of adjusting controls of the light source, adjusting a length of time the liquid resin is exposed to light (for example, effectively turning or flicking the pixels off and on for discrete intervals of time), adjusting a distance the light source is from a region of the resin pool, and adding a filter to the light source. Resin formulation can be altered specifically to affect curing kinetics. For example, higher amounts of either thermal or photo initiators in the formulation result in greater degrees of cure when that form of curing is performed. Different cross-linking agents have different inherent reaction rates also resulting in differing/variable physical and/or mechanical properties.

In one embodiment, during liquid resin based stereolithographic 3D printing processes, liquid resin does not instantaneously polymerize into a desired solid part upon exposure to light. The light delivers a required amount of energy into a voxel of resin to polymerize that voxel into a solid structure over a period of time. The required amount of energy is referred to as the critical energy dosage (“E_{c}”) and varies based on properties associated with the resin. As the build plate is moving away from the light source during the printing process, E_{c} is reached while the resin is at a given height above the bottom of the resin pool during bottom-up printing techniques. During a printing process, there is a certain height at which E_{c} is reached, and the liquid resin begins to polymerize and take on a gelatinized state, referred to as the “gelation point”. A gelation point during a continuous bottom-up 3D print can be determined by the formula:

$${z}_{c} = - {D}_{p} ln ( 1 - \frac{{E}_{c} {v}_{z}}{{D}_{p} {I}_{o}} )$$

where z_{c} is the gelation point, I₀ is the light intensity in mW cm² of the light source at the bottom of the resin pool, Dₚ is the depth of penetration defined as the depth in cm at which the power (P) or light intensity (I) is (1/e) % (approximately 37%) of I₀, and v_{z} is the velocity at which the vertical arm is moving the build plate from the light source.

At the gelation point, gelatinized resin will begin to be pulled away from the energy source by the build plate and liquid resin will flow beneath the gelatinized resin to replace it. Additionally, there is also a height at which the resin is polymerized to the maximum degree during the printing process, referred to as the “cure point.” Between the gelation point and the cure point, the partially cured resin has a gradient of polymerization with greater degrees of polymerization closer to the cure point. The cure point does not define the point at which the resin becomes 100% polymerized as the product undergoes post-print curing before 100% polymerization is achieved. In an example, the green product can have a varied percentage of polymerization across the green product's various regions if the cure point is varied across those regions. Both the gelation point and the cure point for a given resin formulation printing at a given speed can be affected by the intensity of light to which the resin is exposed.

In an embodiment when using a continuous bottom-up method, the gelation point becomes closer to the bottom of the resin pool as the intensity of light increases because the light source administers the E_{c} dosage to a given voxel over a shorter period of time. Since the build plate is pulling printed product away from the light source at a continuous speed, the build plate will be closer to the light source at the time that the E_{c} dosage has been administered. Additionally, as the intensity of light increases, the cure point becomes further from the bottom of the resin pool because the higher intensity of light has a greater depth of penetration compared to a lower intensity of light. Light penetration is determined by the Beer-Lambert Law. The equation for the Beer-Lambert Law is:

$$I = {I}_{0} {e}^{- az}$$

where I is the light intensity at a given point, I₀ is the initial intensity of light from the light source, a is the attenuation coefficient which defines how well light penetrates through a substance (varies with resin formulation) and z is the depth of penetration of the light (cm). Different resin formulations will have different attenuation coefficients based on the components of the resin. In an embodiment, adjusting the composition of the resin is a method of altering the depth of penetration of light, thus altering the gelation and cure points. The Beer-Lambert Law equation is used for a given resin formulation with a given attenuation coefficient to determine what intensities of light will achieve desired gelation and cure points. Depth of penetration (Dₚ) can be found by determining z when a power (P) of the light source is equal to (1/e) % of the initial power (P₀) of the light source given the attenuation coefficient. Once Dₚ is known for a given resin formulation and a given initial light intensity, the cure point for a given area can be further determined using the Jacob's Working Curve. The equation for the Jacob's Working Curve is:

$${C}_{D} = {D}_{p} ln ( {E}_{o} / {E}_{c} )$$

where C_{D} is the cure depth and E₀ is the total amount of energy at the bottom of the resin pool over that unit. A total amount of energy over a given unit increases as the intensity of light increases such that the height of the cure point increases as intensity of light increases given the Dₚ based on the resin formulation.

In an embodiment, a given region in a green product printed using a light intensity with a greater depth of penetration will have a higher percentage of cure when the printing process is complete compared to a given region in a green product printed using a light intensity with a lower depth of penetration. The higher percentage of cure achieved is because the higher intensity of light will administer a higher total amount of energy to the given region. The total amount of energy administered to a given area during a continuous print is determined by the formula:

$${E}_{tot} = \frac{{D}_{p} {P}_{o}}{{v}_{z}}$$

The higher percent cure in a given region in a green product will result in different physical and/or mechanical properties after a post-print curing process when compared to a given region in a green product with a lower percent cure that underwent the same curing process. For example, a faster, more intense printing process will result in a stronger, harder, and more brittle product while a slower, less intense printing process will result in a less hard, more elongated, less brittle product. Additionally, the given region in a green product will continue to be cured on the printer until it reaches a height that is greater than the deepest penetration of any intensity of light used in the z axis of that region. Further, as the product increases in height up until that point, the total amount of energy administered into that given region of the product will increase due to the increased amount of time that radiation was administered into that region leading to a higher percentage of cure during the printing process in that region.

In an embodiment, 3D printing technology allows for variations in the gelation point and the cure point based on the previously described properties such that the light intensity variability along with other additive manufacturing techniques achieve a final product with characteristics novel to the field of 3D printing. A final product having variable physical and/or mechanical properties throughout stemming from a single resin, single printing process, and single curing process can be created.

In an embodiment, grayscaling techniques can be used to create subpixel resolution of products printed using DLP techniques. When grayscaling techniques are combined with varying gelation points and cure points, grayscaling techniques can have an impact on the physical and/or mechanical properties of the finished product. When grayscaling is applied purposefully during a continuous bottom-up printing process to achieve sub-pixel resolution, shape edges, and affect the gelation point and cure point, the total percentage of resin polymerization from the printing process can be altered for specific regions of the green product once the printing process is complete. The percentage of resin polymerization during the printing process is directly proportional to the total amount of energy administered to a given voxel during the printing process. The green product can be cured using light and heat resulting in complete polymerization of the resin within the final product.

The resulting final product contains regions having differing physical and/or mechanical properties based on the percentage of the polymerization of resin in that region that occurred during the printing process compared to the percentage of polymerization in that occurred during the post-print curing process. Ratios of percent cure from printing to percent post-print cure achieve 3D-printed products having variable physical and/or mechanical properties throughout due to differing amounts of chain extension polymerization and cross-linking polymerization that occurs when different combinations of percent cure from printing and percent post-print cure are used for a given liquid resin formulation. The use of varying light intensity during stercolithography techniques to additively manufactured products creates products having varied physical and/or mechanical properties from a single resin formulation, printing process, and post-printing curing process based on differing ratios of polymerization from printing to polymerization from post-print curing in different regions of the product.

In an embodiment, printing processes used to create products with varied physical and/or mechanical properties are dictated by an image stack that is used during the 3D printing process to control the position and intensity of light administered by the light source. Grayscale image stacks can be created that dictate an intensity of light to be used on different regions of the resin pool at different points in time to induce higher levels of polymerization (percent cure) from the printing process in certain regions and lower levels of polymerization (percent cure) in other regions. Regions exposed to higher intensities of light will achieve a higher percent cure from the printing process compared to regions exposed to lower intensities of light. Since all regions will achieve 100% cure when the post-print curing process is complete, regions with lower levels of percent cure from the printing process (photocuring) will have higher levels of percent cure from the post-print curing process (for example, photo and/or thermal curing).

In an example embodiment, 3D-printed products can be creating having different physical and/or mechanical characteristics from a single resin formulation, such as when limited amounts of resin formulations are available. A single resin formulation can create different 3D printed products with different physical and/or mechanical characteristics by varying the percent cure ratio during different printing and post-print curing processes. As physical and/or mechanical properties of a 3D-printed product are primarily altered by selecting a resin formulation specifically designed to create a product with the desired physical and/or mechanical properties, different methods of 3D printing can be used to vary percent cure ratios to create different products with differing physical and/or mechanical properties from a single resin formulation.

In an example embodiment, multiple considerations are necessary when determining percent cure ratios, including the resin formulation. An extensive amount of photocurable liquid resin formulations are possible with differing amounts and types of monomers and oligomers, cross-linking agents, thermal initiators, photoinitiators, photostabilizers, fillers, pigments, and other components. Each unique resin formulation will generate differing physical and/or mechanical properties resulting from different percent cure ratios based on the reactivity of the resin and the reactivity of each different component.

In an example embodiment, the post-print curing process may vary based on the geometry and/or chemistry of the green product. During the post-print curing process, further exposure to light and/or heat may be used. In an example, light is shone onto the outer surface of the green product to further photocure the green product as a significant portion of unreacted resin may be present on the outer surface of the green product following the printing process. The light facilitates polymerization in unreacted resin on the surface of the green product, but the light does not penetrate into the product. Alternatively, thermal post-print curing triggers polymerization throughout the entirety of the green product. The combination of light and/or thermal post-print curing may vary in accordance with the light intensities used during the printing process.

In an example embodiment, the temperature of the resin pool and the surrounding environment can increase due to the exothermic nature of the polymerization reaction during the printing process. The increase in temperature of the resin pool may lead to a certain amount of thermal curing occurring during the printing process when only photocuring should be occurring. Accordingly, the temperature of the printer should be monitored and controlled during the printing process to maintain the ideal percent cure ratios. In an embodiment, the 3D printing process is highly monitored and controlled. Variables such as the temperature of the 3D printed product, resin pool, and surrounding environment, forces applied during the printing process, and the amount, rate, and intensity of light exposure may be monitored. The variables may be monitored, managed, and manipulated in real time in order to ensure that the desired percent cure ratios are achieved during the printing and post-print curing process.

An additional method of controlling the localized physical and/or mechanical properties of a 3D printed part is affecting the density of the polymer network of the part. As discussed previously, controlling various aspects of the printing process can affect the degree of polymerization achieved during the printing process. Using these techniques in combination with the inherent property of shrinkage present in photopolymerized 3D printed parts, localized manipulation of the actual density of the polymer network is also possible due to geometric constraint. Shrinkage occurs as a part of the 3D printing process. Shrinkage occurs as the green product is no longer being exposed to radiation. Once the green product is no longer under the influence of radiation (i.e., light), there is no longer an input of energy into the partially cured resin and the polymerization process slows then stops until further energy is placed into the system. Shrinkage then occurs as the product cools and becomes more inert. Shrinkage can vary 0.25% to 10% based on a variety of factors including, but not limited to, the total number of bonds formed during a printing process, steric hinderances in the backbone of the resin chemistry, and polarity and phase separation of the polymer network, among other factors. The primary factor that dictates the amount of shrinkage that occurs in a photopolymerized green product is the amount of time the green product or a region of the green product is not exposed to any radiation following a printing process. The longer a product is allowed to rest, the more shrinkage will occur up to a maximum value of shrinkage based on the other factors detailed above, among others. Leveraging shrinkage and changes in intensity can allow for localized control of the density of the polymer network in a 3D printed part.

In an example, a 3D printed product is desired to have (in the 7-direction) an area of high polymer network density adjacent to an area of low network polymer density. An example of a suitable method of achieving this would be to first print the area of high density. This printing would be done typically with a higher degree of on-printer polymerization desired in the high-density region as compared to the lower density region. The high-density region would then be allowed to undergo shrinkage by ceasing exposure of that region to radiation. The absolute shrinkage of the high-density region would be dependent on a number of factors primarily related to resin formulation; however, some degree of shrinkage will occur with any resin formulation. Once the shrinkage occurs, the high-density region is then reintroduced to the energy source. This would allow for additional resin to be cured on top of the already shrunk resin, which would achieve the high-density region of the product, ensure that the shrinkage of the product is compensated for, the dimensions are precise, and geometrically constrain adjacent regions of the product. This achieves an effectively “tight” network, meaning that the components of the network are very close to one another resulting in greater mechanical strength, toughness and brittleness as compared to a “looser” network. This geometric constraint allows for the low-density region to be formed adjacent to the high-density region.

In an example, following formation of the high-density region, the low-density region is polymerized onto or underneath the high-density region (top-down versus bottom-up printers are interchangeable for the purposes of this example). In an example, the low-density region undergoes a lower degree of polymerization compared to the higher density region. In an example, the low-density region undergoes a higher degree of polymerization compared to the higher density region. Here, the shrinkage that occurs when the low-density region is no longer exposed to the radiation source is significantly less than the degree of shrinkage that would have occurred had the low-density region not been geometrically constrained. This example method achieves the multi-faceted benefit of controlling the shrinkage in low-density regions of the product and allowing for the manipulation and control of localized regions of the polymer network in a 3D-printed part. Varying network densities throughout the product can allow for both macro-level and micro-level control of the properties of the product. Macro-level properties affected by network density include mechanical properties, such as strength and elongation, and specific gravity. Micro-level properties affected by network density include steric hinderance in the polymer backbone, optical properties (index of refraction, opacity, etc.) and polarity, among others.

An additional method exists for affecting network density of a 3D printed part. When a resin formulation is cured into a product, excess resin exists in and on the product. Any typical photopolymerized product undergoes a washing step following photopolymerization in order to remove this excess resin from the product. The washing step typically occurs prior to any off printer curing or post-processing of the product, and involves using a liquid in order to remove the excess resin. In an example, this can be achieved by spraying the part, soaking the part, or any suitable traditional washing technique. In an example, a suitable liquid for use in a wash step is Isopropyl Alcohol. An example method of controlling network density in a 3D printed product is to localize, measure, control, and change how much resin is removed from a product during this washing step.

In an example, two green products are formed having the same degree of polymerization and amount of cured and uncured resin, and it is desired for these products to be very similar except one is to have a relatively lower network density compared to the other. In an example, following the printing process, the green products will be washed, and then further curing will occur to ensure 100% polymerization of all resin present in the green product. In an example, a lower degree of network density is achieved by washing the green product that will have a lower network density for a longer period of time. This causes more of the uncured resin to be removed from the lower density product compared to the higher density product. Thus, after further curing occurs and all resin present in the final product has 100% polymerized, the two products will have extremely similar structures and geometries; however, one of the products has a lower network density due to having less overall resin present in the same geometry. In an example, this method is used instead to affect the network density of two regions of the same product. In an example, a first region of a product undergoes a washing step for a longer period of time than a second region of the product, causing that first region to have a lower network density in the final product compared to the second region. In an example, a region where a low network density is desired will undergo less polymerization during the printing process compared to a region where high density is desired.

The main mechanical properties influenced by the ratio of cross-linking to chain extension within the polymer network are strength and elongation. Strength is the measure of stress that a polymer will undergo before deforming. Elongation is the measure of how much a material will stretch and still return to its original shape. In an example, high ratios of cross-linking to chain extension will result in a tougher or more rigid material with higher strength and lower elongation. In an example, high ratios of chain extension to cross-linking will result in a more flexible or elastic material with higher elongation and lower strength. In an example, these properties can be measured using different types of directional forces including compression, tension, shear, torsion, or bending. A product's mechanical properties can be defined by how the product reacts when those different forces are applied to the product. In an example, a product has different mechanical properties for different directional forces. For example, a product can have a high degree of tensile strength with low tensile elongation while having a high degree of shear elongation with low shear strength. The direction of the material properties of the product can be influenced by the design of the product, the ratio of chain extension to cross-linking within different regions of the product, and the orientation of the product.

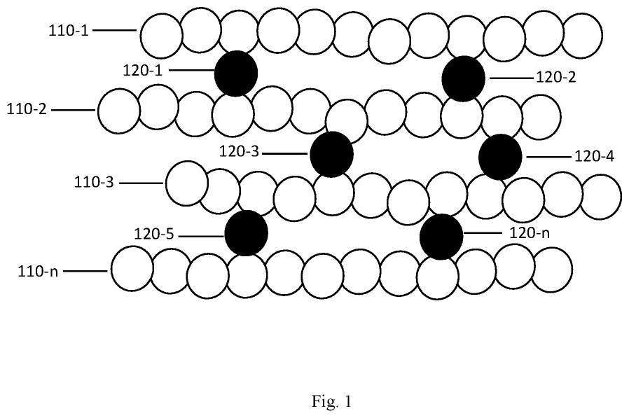

FIG. 1 is an illustration depicting a representation of a uniform polymer network with an equal amount of cross-linking and chain extension. FIG. 1 depicts polymer chains 110 (depicted as 110-1 through 110-n to indicate a plurality of polymer chains) and cross-linking agents 120 (depicted as 120-1 through 120-n to indicate a plurality of cross-linking agents). As depicted in FIG. 1, a first polymer chain 110-1 is connected to a second polymer chain 110-2 by cross-linking agents 120-1 and 120-2.

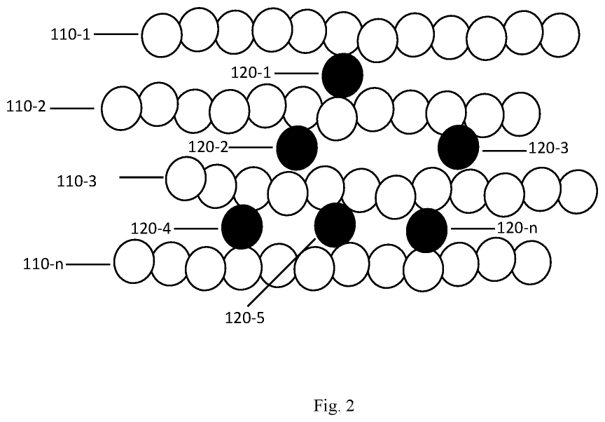

FIG. 2 is an illustration depicting a representation of a polymer network with varying amounts of cross-linking. The upper portion of the illustration represents a region with a low percentage of cross-linking, as represented by fewer occurrences of cross-linking agents 120, as compared to the lower portion with a high percentage of cross-linking, as represented by more occurrences of cross-linking agents 120. In an example, a printed product with this polymer network would have more elongation and elastic properties in the upper portion where the ratio of chain extension to cross-linking is greater. Conversely, the lower portion represents a region of the product where the ratio of chain extension to cross-linking is lower, resulting in a stronger and more brittle region of the printed product.

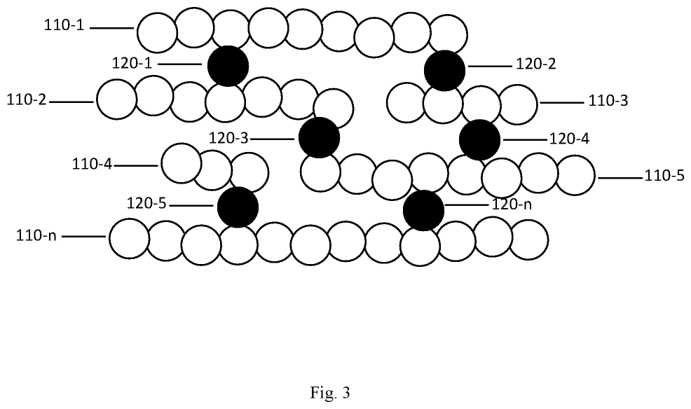

FIG. 3 is an illustration depicting a representation of a polymer network with regions having differing ratios of chain extension to cross-linking. The differing ratios of chain extension to cross-linking result in varying physical and/or mechanical properties across the regions. As depicted in FIG. 3, the amount of cross-linking, as represented by the occurrences of cross-linking agents 120, remains constant throughout with the amount of chain extension varying to generate the differing ratios. As previously described in regard to FIG. 2, a greater ratio of chain extension to cross-linking results in more elongation and elastic properties, while a lower ratio of chain extension to cross-linking results in a stronger and more brittle region of the printed product.

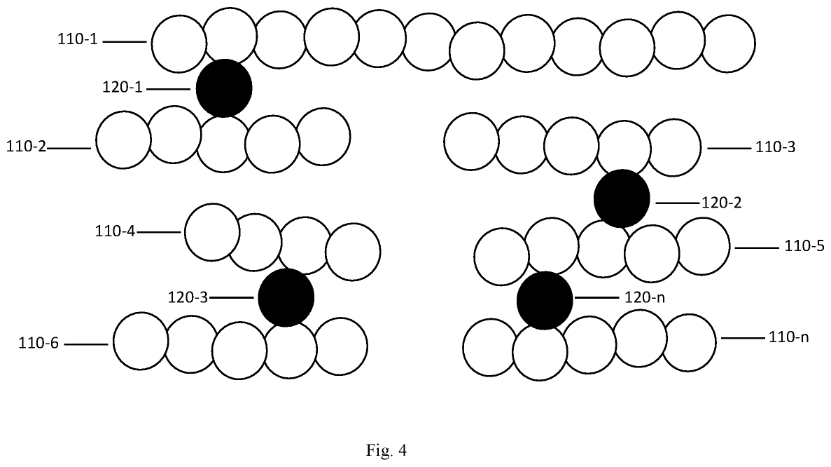

FIG. 4 is an illustration depicting an example embodiment of a polymer network associated with a hinge. As depicted in FIG. 4, the width of the upper portion of the polymer network has a high ratio of chain extension to cross-linking resulting in a flexible portion of the hinge with elastomeric properties. On either side of the substantially empty space in the center/middle portion of the polymer network, there is a lower ratio of chain extension to cross-linking resulting in stronger, tougher regions on either side of the flexible portion.

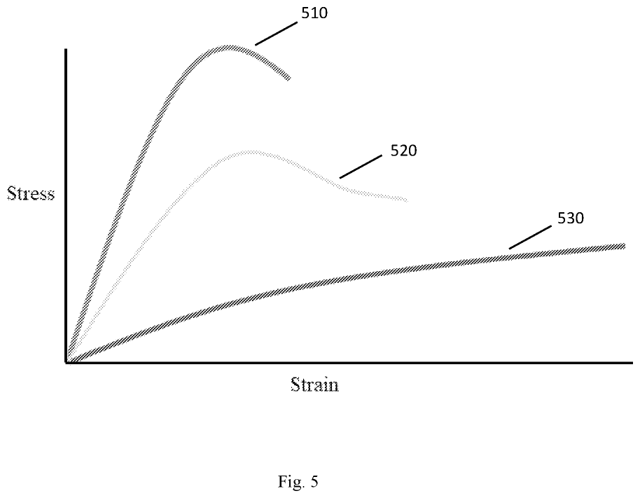

FIG. 5 depicts example stress versus strain curves for printed materials exposed to varying light intensities. As depicted in FIG. 5, varying print parameters may influence reaction rates resulting in changed physical and/or mechanical properties of the printed material. Curves 510 and 520 depict stress versus strain for cured materials comprising the same resin composition but exposed to varying light intensities. Curve 510 depicts a stress versus strain curve for a cured material exposed to a higher dose of ultraviolet (“UV”) light as compared to the cured material of curve 520. The lower UV dose of the cured material of curve 520 results in lower strength and higher elongation as compared to the cured material of curve 510. In an example, the resin composition is G-RS-601, the UV exposure for the cured material of curve 510 is 4 minutes, and the UV exposure for the cured material of curve 520 is 1 minute. Curve 530 depicts stress versus strain for a cured material comprised of a different resin than the cured materials of curves 510 and 520. The UV exposure for the cured material of curve 530 is 4 minutes, which demonstrates that different resin formulations have unique physical and/or mechanical properties that must be accounted for when determining the parameters of a printing process. The cured material of curve 530 was a significantly lower strength, higher elongation product than the cured material of curve 510 despite equal amounts of UV exposure. The printed material of curve 530 was exposed to the same light intensity as the printed material of curve 510.

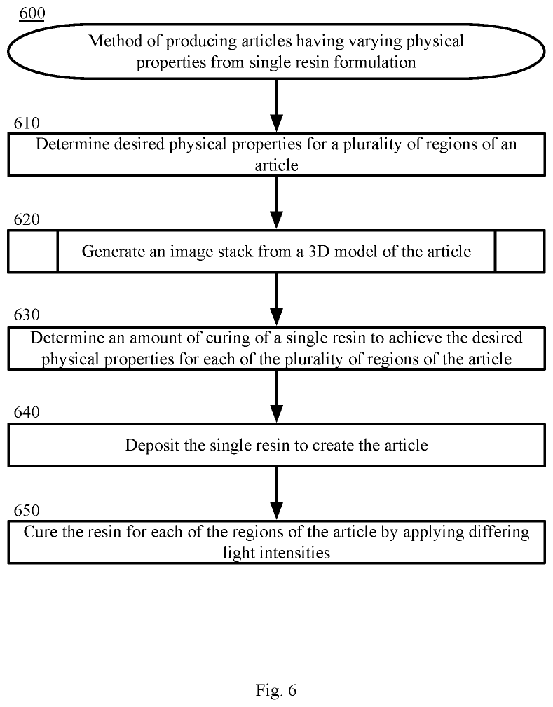

FIG. 6 is a block flow diagram depicting a method 600 of producing articles having varying physical properties from a single resin formulation, in accordance with certain examples. In block 610, desired physical properties for a plurality of regions of an article are determined. In an example, the article is a 3D printed product. In an example, the physical and/or mechanical properties are associated with a strength and/or an elongation desired in the plurality of regions of the article or optical properties such as reflectivity, absorptivity, refractivity, transparency, translucency, opaqueness, and luminescence.

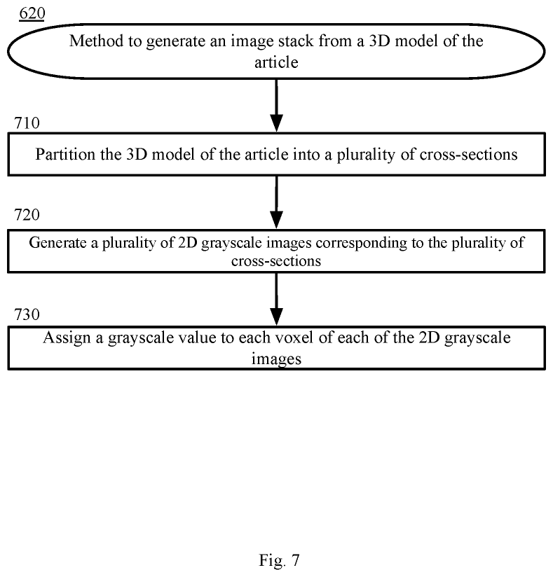

In block 620, an image stack is generated from a 3D model of the article. Block 620 is described in greater detail herein with respect to method 620 of FIG. 7.

FIG. 7 is a block flow diagram depicting a method 620 of generating an image stack from a 3D model of the article, in accordance with certain examples. In block 710, the 3D model of the article is partitioned into a plurality of cross-sections. In block 720, a plurality of 2D grayscale images are generated corresponding to the plurality of cross-sections. Each of the 2D grayscale images corresponds to a particular cross-section of the plurality of cross-sections. In block 730, a grayscale value is assigned to each voxel of each of the 2D grayscale images. In an example, the grayscale value indicates a light intensity value. In an example, the grayscale value varies between a lower limit and an upper limit, with the lower limit representing a lowest light intensity and the upper limit representing a highest light intensity. In an example, the lower limit may be 0 indicating an absence of light and the upper limit may be I indicating the greatest light intensity available. In an example, depending on the desired physical and/or mechanical properties, a ratio of cross-linking to chain extension for a given region of the product is developed for a given formulation that will provide that region with the desired physical and/or mechanical properties, which allows for the determination of how much curing should occur on versus off the printer and thermal versus UV. The desired on printer curing can be achieved by altering the intensity of light administered to specific voxels of resin using gray scaling techniques, and these gray scaling techniques are applied during the generation of the image stack, i.e., not only determining the geometry of the product on a voxel level but also the intensity of light that each voxel receives at a given point during the printing process. In an example, the image stack defines a light intensity dosage that each voxel of the article will be exposed to during a manufacturing process. In an example, the manufacturing process is a vat polymerization process. In an example, the manufacturing process is an additive manufacturing process, such as a continuous bottom-up direct light processing (“DLP”) additive manufacturing process. In an example, the image stack is a grayscale image stack. In an example, the image stack is generated based on a CAD of the article. From block 730, the method 620 returns to block 630 of FIG. 6.

In block 630, an amount of curing of a single resin is determined to achieve the desired physical properties for each of the plurality of regions of the article. In an example, the amount of curing is a percent cure ratio. In an example, the percent cure ratio is a ratio of a percent cure occurring during a 3D printing process to a percent cure occurring during a post-print curing process. In an example, the percent cure ratio is determined based on one or more of a resin formulation, a geometry of the article, and a print temperature, among other factors. These parameters help to define the chemistry that will occur during the printing process, and they will be considered to determine how to achieve the desired physical and/or mechanical properties in the final product. In an example, the percent cure ratio varies based upon a resin printer combination. As different resins and printers have different parameters, one resin printer combination may use a 70%-30% extension to cross-linking ratio to achieve a desired mechanical property while a second resin printer combination may achieve the same desired mechanical property with a 50%-50% extension to cross-linking ratio. In an example, aspects of resin formulation used to determine the percent cure ratio include amounts and types of resin monomers and/or oligomers, cross-linking agents, thermal initiators, photoinitiators, photostabilizers, fillers, and pigments.

In block 640, the single resin is deposited to create the article.

In block 650, the resin is cured for each of the regions of the article by applying differing light intensities. Differing light intensities are applied to each respective region of the article to cure each respective region of the article in an amount corresponding to the desired physical and/or mechanical properties for each respective region. The article is generated from the single resin. In an example, the article is generated from the single resin using 3D printing as the manufacturing process and applying varying light intensity dosages to each voxel of the article as defined in the image stack. In an example, varying the light intensity dosages applied to each voxel is achieved by varying the intensity of a light source. In an example, the light source is a light projector. In an example, the light source is a DLP light source. In an example, the light source is a laser. In an example, light intensity may be varied by masking pixels or rapidly turning pixels off and on to control the total light intensity over a given pixel.

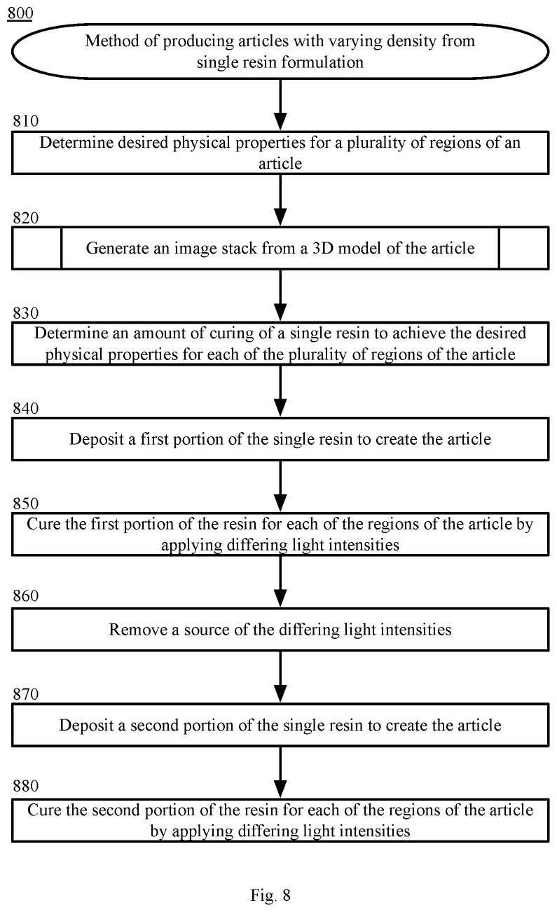

FIG. 8 is a method of producing articles with varying density from a single resin formulation, in accordance with certain examples. In block 810, desired physical properties are determined for a plurality of regions of an article. In block 820, an image stack is generated from a 3D model of the article. In block 830, an amount of curing of a single resin is determined to achieve the desired physical properties for each of the plurality of regions of the article. Blocks 810-830 are described in greater detail herein with reference to blocks 610-630 of FIG. 6.

In block 840, a first portion of the single resin is deposited to create the article. In block 850, the first portion of the resin is cured for each of the regions of the article by applying differing light intensities. Differing light intensities are applied to each respective region of the article to cure each respective region of the article in an amount corresponding to the desired physical and/or mechanical properties for each respective region. In block 860, a source of the differing light intensities is removed. In an example, the light source is turned off. Removing the source from the first portion of the resin allows a shrinkage of the first portion of the resin. When the desired amount of shrinkage occurs, the method proceeds to block 870. In block 870, a second portion of the single resin is deposited to create the article. In block 880, the second portion of the resin is cured for each of the regions of the article by applying differing light intensities. In an example, the first portion of the resin comprises a higher density as compared to the second portion of the resin. In an example, the second portion of the resin is geometrically bound to the first portion of the resin.

The physical and/or mechanical properties of the article may be further controlled based on removal of excess resin from the article prior to off printer curing or post-processing of the article. In an example, the photopolymerized product (i.e., the article) undergoes a washing step following photopolymerization in order to remove excess resin from the product. In an example, the washing step occurs prior to any off printer curing or post-processing of the product, and involves using a liquid in order to remove the excess resin. In an example, this can be achieved by spraying the part, soaking the part, or any suitable traditional washing technique. An example method of controlling network density in a 3D printed product is to localize, measure, control, and change how much resin is removed from a product during this washing step. In an example, a longer wash time removes more excess resin as compared to a shorter wash time resulting in a lower density.

The methods described herein with respect to FIGS. 6-8 may be implemented by one or more computing devices, such as those described with reference to FIG. 9.

### EXAMPLE EMBODIMENTS

An example embodiment is a 3D printed, single-piece hinge created from a single resin formulation, a single printing process, and post-print curing process. In an example, the outer components of the hinge are stiff and rigid while the inner region of the hinge has a high level of elasticity such that the hinge can bend and stretch while retaining its shape. A resin formulation is selected that is capable of achieving both the rigidity for the outer components and the elasticity for the inner region. To achieve the variation in physical and/or mechanical properties, the inner region has a lower level of cross-linking to provide a high level of elasticity, and the outer components have higher levels of cross-linking to provide rigidity. A ratio of desired percent cure from the print process and percent cure from the post-print curing process (referred to as the “percent cure ratio”) is determined for each region based on the resin formulation and the ratios of cross-linking. In an example due to the large number of possible resin formulations, experimentation may be used to determine ratios of percent cure from light and heat that will lead to specific physical characteristics. In an alternate example, a machine learning algorithm may be used to determine ratios of percent cure from light and heat that will lead to specific physical characteristics. For example using a single resin formulation, product strength and elongation properties may be input into the machine learning algorithm with the algorithm outputting chain elongation to cross-linking ratios, percent cure from UV and/or heat, and/or percent cure from on printer versus percent cure off printer. A grayscale image stack is created based on a CAD of the hinge that will dictate the intensity of light each region of the hinge is exposed to. The resin undergoes a 3D printing process and post-print photo and thermal curing process achieving 100% polymerization throughout and the desired physical and/or mechanical properties in the different regions. In an example, the inner region of the hinge is exposed to lower intensities of light during the printing process, achieving a 30% total cure in the green product. Thus, 70% of the total cure of the inner region occurred during the post-print curing process, leading to low levels of cross-linking and highly elastic mechanical properties. The outer components, alternatively, were exposed to higher intensities of light during the printing process, achieving a 70% total cure in the green product. Thus, 30% of the total cure of the outer components occurred during the post-print curing process, leading to high levels of cross-linking in the region making the region more rigid.

### Other Examples

FIG. 9 depicts a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPL”), a field programmable gate array (“FPGA”), a programmable logic device (“PLD”), a controller, a state machine, gated logic, discrete hardware components, any other processing unit, or any combination or multiplicity thereof. The processor 3010 may be a single processing unit, multiple processing units, a single processing core, multiple processing cores, special purpose processing cores, co-processors, or any combination thereof. The processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 3050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement microcontroller protocols such as I2C, Serial Peripheral Interfaces (“SPI”), UART, and Controller Area Network (“CAN”). The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include WANs, LANs, intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. Any of the processor 2010, the other elements of the computing machine 2000, or the various peripherals discussed herein may be integrated into a single device such as a system on chip (“SOC”), system on package (“SOP”), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those skilled in the art will appreciate that one or more aspects of examples described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. Computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The systems, methods, and acts described in the examples presented previously are illustrative, and, alternatively, certain acts can be performed in a different order, in parallel with one another, omitted entirely, and/or combined between different examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

What is claimed is:

1. A method of producing articles having varying physical properties from single resin formulations, comprising:
depositing a resin to create an article; and
curing the resin at a plurality of different regions of the article by applying differing light intensities to each respective region of the article to cure each respective region of the article in an amount corresponding to desired physical properties for each respective region.

2. The method of claim 1, further comprising generating an image stack from a 3-dimensional model of the article, the image stack defining a light intensity to which each voxel of the article will be exposed.

3. The method of claim 2, wherein generating the image stack from the 3-dimensional model of the article comprises:
partitioning the 3-dimensional model into a plurality of cross-sections;
generating a plurality of 2-dimensional grayscale images, each 2-dimensional grayscale image corresponding to a particular cross-section of the plurality of cross-sections; and
assigning a grayscale value to each voxel comprised within each of the 2-dimensional grayscale images,
wherein the grayscale value indicates a light intensity value and varies between a lower limit and an upper limit, the lower limit representing a lowest light intensity and the upper limit representing a highest light intensity.

4. The method of claim 3, wherein the differing light intensities correspond to the grayscale values of the image stack.

5. The method of claim 1, wherein differing the light intensities comprises one or more of varying the intensity of a light source, adjusting a length of time of light exposure, adjusting a distance of the light source, or applying a filter to the light source.

6. The method of claim 1, further comprising controlled removal of excess resin from the article in accordance with the desired physical properties.

7. The method of claim 6, where in the controlled removal of excess resin comprises removal of the excess resin based on one or more of a location on the article, a wash time, or a measurement of the excess resin.

8. The method of claim 1, wherein the cure amount is determined, based at least in part, on one or more of resin formulation, geometry of the article, and print temperature.

9. The method of claim 8, wherein aspects of resin formulation used to determine the cure amount include amounts and types of resin monomers and/or oligomers, cross-linking agents, thermal initiators, photoinitiators, photostabilizers, fillers, and pigments.

10. The method of claim 1, wherein the desired physical properties comprise varying strength, elongation, and optical properties.

11. The method of claim 1, wherein depositing the resin to create the article is a vat polymerization process or an additive manufacturing process.

12. The method of claim 11, wherein the additive manufacturing process is a continuous bottom-up direct light processing (DLP) additive manufacturing process.

13. A method to control localized physical properties of a 3-dimensional printed article, comprising:
depositing a first portion of a resin to create an article;
curing the first portion of the article by applying differing light intensities to one or more regions of the first portion of the article to cure each respective region of the article in an amount corresponding to the desired physical properties for each respective region;
removing a source of the differing light intensities from the first portion of the resin, wherein removing the source from the first portion of the resin allows a shrinkage of the first portion of the resin;
depositing a second portion of the resin to the article; and
curing the second portion by applying differing light intensities to each one or more regions of the second portion to cure each respective region of the article in an amount corresponding to the desired physical properties for each respective region.

14. The method of claim 13, wherein the first portion of the resin forms a high-density region of the article.

15. The method of claim 13, wherein the second portion of the resin forms a low-density region of the article.

16. A method of producing articles having varying physical properties from single resin formulations, comprising:
by one or more computing devices:
determining desired physical properties for each of a plurality of regions of an article;
determining an amount of curing of a single resin to achieve the desired physical properties for each of the plurality of regions of the article;
depositing the resin to create the article; and
curing the resin for each of the regions of the article by applying differing light intensities to each respective region of the article to cure each respective region of the article in an amount corresponding to the desired physical properties for each respective region.

17. The method of claim 16, further comprising generating, by the one or more computing devices, an image stack from a 3-dimensional model of the article, the image stack defining a light intensity to which each voxel of the article will be exposed.

18. The method of claim 17, wherein generating the image stack from the 3-dimensional model of the article comprises:
by the one or more computing devices:
partitioning the 3-dimensional model into a plurality of cross-sections;
generating a plurality of 2-dimensional grayscale images, each 2-dimensional grayscale image corresponding to a particular cross-section of the plurality of cross-sections; and
assigning a grayscale value to each voxel comprised within each of the 2-dimensional grayscale images,
wherein the grayscale value indicates a light intensity value and varies between a lower limit and an upper limit, the lower limit representing a lowest light intensity and the upper limit representing a highest light intensity.

19. The method of claim 18, wherein the differing light intensities correspond to the grayscale values of the image stack.

20. The method of claim 16, wherein differing the light intensities comprises one or more of varying the intensity of a light source, adjusting a length of time of light exposure, adjusting a distance of the light source, or applying a filter to the light source.

21. The method of claim 16, further comprising controlled removal of excess resin from the article in accordance with the desired physical properties.

22. The method of claim 21, where in the controlled removal of excess resin comprises removal of the excess resin based on one or more of a location on the article, a wash time, a measurement of the excess resin.

23. The method of claim 16, wherein the cure amount is determined, based at least in part, on one or more of resin formulation, geometry of the article, and print temperature.

24. The method of claim 23, wherein aspects of resin formulation used to determine the cure amount include amounts and types of resin monomers and/or oligomers, cross-linking agents, thermal initiators, photoinitiators, photostabilizers, fillers, and pigments.

25. The method of claim 16, wherein the desired physical properties comprise varying strength, elongation, and optical properties.

26. The method of claim 16, wherein depositing the resin to create the article is a vat polymerization process or an additive manufacturing process.

27. The method of claim 26, wherein the additive manufacturing process is a continuous bottom-up direct light processing (DLP) additive manufacturing process.
